(19) United States
(12) Patent Application Publication
(10) Pub. No.: US 2025/0247912 A1
(43) Pub. Date: Jul. 31, 2025

(54) PROCEDURES FOR SMALL DATA TRANSMISSION

(71) Applicant: QUALCOMM Incorporated, San Diego, CA (US)

(72) Inventors: Jing LEI, San Diego, CA (US); Peter GAAL, San Diego, CA (US); Krishna Kiran MUKKAVILLI, San Diego, CA (US)

(21) Appl. No.: 18/425,994

(22) Filed: Jan. 29, 2024

(51) Int. Cl. H04W 76/20; H04W 72/0457; H04W 72/231; H04W 74/0836

(52) U.S. Cl. CPC H04W 76/20; H04W 72/0457; H04W 72/231; H04W 74/0836

(57) ABSTRACT

Methods, systems, and devices for wireless communications are described. A network entity may transmit small data transmission (SDT) initialization information in a first message of a random-access procedure, wherein the SDT initialization information indicates an identification of the network entity for association with an SDT procedure. The network entity may transmit SDT data after completion of the random-access procedure and as part of the SDT procedure, wherein transmission of the SDT data is over a configured grant resource set.

### INTRODUCTION

The following relates to wireless communications, including procedures for small data transmission. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Aspects of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support procedures for small data transmission (SDT). The described techniques provide for improved SDT techniques that improve the flexibility, power, and spectral efficiency. One aspect of the described techniques may provide for a user equipment (UE) to initiate an SDT procedure via contention-free random access (CFRA) or contention-based random access (CBRA) resources and continue the SDT procedure after the random-access channel (RACH) procedure using Type-1 or Type-2 configured grant (CG) resources. This may include a network entity (e.g., a UE) transmitting or otherwise providing SDT initialization information in a first message of a random-access procedure. The SDT initialization information may carry or otherwise convey an indication of an identification of the UE for association with the SDT procedure. The UE may transmit SDT data after the RACH procedure as part of the SDT procedure. The UE may transmit the additional SDT after the RACH procedure using the Type-1 or Type-2 CG resources.

Additionally, or alternatively, aspects of the described techniques may provide for SDT initialization where the subsequent SDT being configured in the same or in different bandwidth parts (BWPs). The network entity (e.g., a UE) may transmit or otherwise provide the SDT initialization information during the RACH procedure and via a first BWP. The SDT initialization information may indicate the identification of the network entity for association with the SDT procedure. The UE may receive or otherwise obtain a BWP trigger that initiates or otherwise triggers the UE to switch from the first BWP to a second BWP for the SDT procedure. Accordingly, the UE may transmit SDT data in the second BWP as part of the SDT procedure in response to the BWP trigger. The UE may again transmit the SDT data using Type-1 or Type-2 CG resources.

A method for wireless communications by a network entity is described. The method may include transmitting SDT initialization information in a first message of a random-access procedure, where the SDT initialization information indicates an identification of the network entity for association with an SDT procedure and transmitting SDT data after completion of the random-access procedure and as part of the SDT procedure, where transmission of the SDT data is over a CG resource set.

A network entity for wireless communications is described. The network entity may include a processing system configured to transmit SDT initialization information in a first message of a random-access procedure, where the SDT initialization information indicates an identification of the network entity for association with an SDT procedure and transmit SDT data after completion of the random-access procedure and as part of the SDT procedure, where transmission of the SDT data is over a CG resource set.

Another network entity for wireless communications is described. The network entity may include means for transmitting SDT initialization information in a first message of a random-access procedure, where the SDT initialization information indicates an identification of the network entity for association with an SDT procedure and means for transmitting SDT data after completion of the random-access procedure and as part of the SDT procedure, where transmission of the SDT data is over a CG resource set.

A non-transitory computer-readable medium having code for wireless communications stored thereon is described. The code, when executed by the network entity causes the network entity to transmit SDT initialization information in a first message of a random-access procedure, where the SDT initialization information indicates an identification of the network entity for association with an SDT procedure and transmit SDT data after completion of the random-access procedure and as part of the SDT procedure, where transmission of the SDT data is over a CG resource set.

Some examples of the method, network entities, and non-transitory computer-readable medium described herein may further include operations, features, means, or instructions for receiving an indication of a random-access resource set for the random-access procedure, where the SDT initialization information may be transmitted in the random-access resource set.

In some examples of the method, network entities, and non-transitory computer-readable medium described herein, the random-access resource set includes dedicated SDT resources for the SDT procedure and the identification of the network entity may be indicated in the SDT initialization information based on the random-access resource set that includes the dedicated SDT resources for the SDT procedure.

Some examples of the method, network entities, and non-transitory computer-readable medium described herein may further include operations, features, means, or instructions for indicating a request for the SDT procedure in the first message based on the random-access resource set that includes the non-dedicated SDT resources for the SDT procedure.

In some examples of the method, network entities, and non-transitory computer-readable medium described herein, the random-access resource set may be received in a radio resource control (RRC) release message, a downlink control information (DCI) message, a system information message, or a medium access control-control element (MAC-CE).

In some examples of the method, network entities, and non-transitory computer-readable medium described herein, the random-access resource set includes a CFRA resource set or a CBRA resource set.

Some examples of the method, network entities, and non-transitory computer-readable medium described herein may further include operations, features, means, or instructions for indicating a request for the SDT procedure in the first message, where the request for the SDT procedure activates the CG resource set.

Some examples of the method, network entities, and non-transitory computer-readable medium described herein may further include operations, features, means, or instructions for transmitting a status report or an assistance information message in the first message during the random-access procedure.

Some examples of the method, network entities, and non-transitory computer-readable medium described herein may further include operations, features, means, or instructions for transmitting an additional status report or an additional assistance information message using the CG resource set and during the SDT procedure.

In some examples of the method, network entities, and non-transitory computer-readable medium described herein, the additional status report or the additional assistance information message include one or more of a buffer status report, a power headroom report, measurements associated with mobility procedures, a channel state information report, beam management information, a traffic profile, a power saving requirement, or any combination thereof.

In some examples of the method, network entities, and non-transitory computer-readable medium described herein, the SDT initialization information may be transmitted while the network entity may be in an RRC active state or in an RRC inactive state.

In some examples of the method, network entities, and non-transitory computer-readable medium described herein, the CG resource set includes Type-1 CG resources or Type-2 CG resources.

In some examples of the method, network entities, and non-transitory computer-readable medium described herein, transmission of the SDT initialization information initiates the SDT procedure.

In some examples of the method, network entities, and non-transitory computer-readable medium described herein, the network entity includes a UE.

A method for wireless communications by a network entity is described. The method may include transmitting SDT initialization information in a first message of a random-access procedure via a first BWP, where the SDT initialization information indicates an identification of the network entity for association with an SDT procedure, receiving a trigger for BWP switching during the SDT procedure, where the trigger for BWP switching initiates a switch from the first BWP to a second BWP for the SDT procedure, and transmitting SDT data in the second BWP as part of the SDT procedure in accordance with the trigger for BWP switching, where transmission of the SDT data is over a CG resource set.

A network entity for wireless communications is described. The network entity may include a processing system configured to transmit SDT initialization information in a first message of a random-access procedure via a first BWP, where the SDT initialization information indicates an identification of the network entity for association with an SDT procedure, receive a trigger for BWP switching during the SDT procedure, where the trigger for BWP switching initiates a switch from the first BWP to a second BWP for the SDT procedure, and transmit SDT data in the second BWP as part of the SDT procedure in accordance with the trigger for BWP switching, where transmission of the SDT data is over a CG resource set.

Another network entity for wireless communications is described. The network entity may include means for transmitting SDT initialization information in a first message of a random-access procedure via a first BWP, where the SDT initialization information indicates an identification of the network entity for association with an SDT procedure, means for receiving a trigger for BWP switching during the SDT procedure, where the trigger for BWP switching initiates a switch from the first BWP to a second BWP for the SDT procedure, and means for transmitting SDT data in the second BWP as part of the SDT procedure in accordance with the trigger for BWP switching, where transmission of the SDT data is over a CG resource set.

A non-transitory computer-readable medium having code for wireless communications stored thereon is described. The code, when executed by a network entity, causes the network entity to transmit SDT initialization information in a first message of a random-access procedure via a first BWP, where the SDT initialization information indicates an identification of the network entity for association with an SDT procedure, receive a trigger for BWP switching during the SDT procedure, where the trigger for BWP switching initiates a switch from the first BWP to a second BWP for the SDT procedure, and transmit SDT data in the second BWP as part of the SDT procedure in accordance with the trigger for BWP switching, where transmission of the SDT data is over a CG resource set.

Some examples of the method, network entities, and non-transitory computer-readable medium described herein may further include operations, features, means, or instructions for receiving an indication of a CFRA resource set and a CBRA resource set for the random-access procedure, where the SDT initialization information may be transmitted in the CFRA resource set or the CBRA resource set.

Some examples of the method, network entities, and non-transitory computer-readable medium described herein may further include operations, features, means, or instructions for prioritizing the CFRA resource set over the CBRA resource set for transmission of the SDT initialization information based on a channel performance metric satisfying a channel performance threshold or based on a non-expiration status of a timer associated with the CFRA resource set.

Some examples of the method, network entities, and non-transitory computer-readable medium described herein may further include operations, features, means, or instructions for prioritizing the CBRA resource set over the CFRA resource set for transmission of the SDT initialization information based on a channel performance metric failing to satisfy a channel performance threshold or based on an expiration status of a timer associated with the CFRA resource set.

Some examples of the method, network entities, and non-transitory computer-readable medium described herein may further include operations, features, means, or instructions for receiving an indication of a CBRA resource set for the random-access procedure, where the CBRA resource set includes a two-step random-access procedure or a four-step random-access procedure.

Some examples of the method, network entities, and non-transitory computer-readable medium described herein may further include operations, features, means, or instructions for prioritizing the two-step random-access procedure over the four-step random-access procedure for transmission of the SDT initialization information based on a channel performance measurement that satisfies a channel performance threshold, based on a non-expiration status of a timer associated with the CBRA resource set, or based on a message retransmission counter that may be below a retransmission count threshold.

Some examples of the method, network entities, and non-transitory computer-readable medium described herein may further include operations, features, means, or instructions for prioritizing the four-step random-access procedure over the two-step random-access procedure for transmission of the SDT initialization information based on a channel performance measurement that fails to satisfy a channel performance threshold, based on an expiration status of a timer associated with the CBRA resource set, or based on a message retransmission counter that may have reached a retransmission count threshold.

In some examples of the method, network entities, and non-transitory computer-readable medium described herein, the trigger for BWP switching may be received in an RRC message, a MAC-CE, or a DCI message.

In some examples of the method, network entities, and non-transitory computer-readable medium described herein, the CG resource set includes Type-1 CG resources or Type-2 CG resources.

In some examples of the method, network entities, and non-transitory computer-readable medium described herein, transmission of the SDT initialization information initiates the SDT procedure.

In some examples of the method, network entities, and non-transitory computer-readable medium described herein, the network entity includes a UE.

### BRIEF DESCRIPTION OF THE DRAWINGS

FIG. 1 shows an example of a wireless communications system that supports procedures for small data transmission (SDT) in accordance with one or more aspects of the present disclosure.

FIG. 2 shows an example of a swim diagram that supports procedures for SDT in accordance with one or more aspects of the present disclosure.

FIG. 3 shows an example of a swim diagram that supports procedures for SDT in accordance with one or more aspects of the present disclosure.

FIG. 4 shows an example of a bandwidth configuration that supports procedures for SDT in accordance with one or more aspects of the present disclosure.

FIGS. 5 and 6 show block diagrams of devices that support procedures for SDT in accordance with one or more aspects of the present disclosure.

FIG. 7 shows a block diagram of a communications manager that supports procedures for SDT in accordance with one or more aspects of the present disclosure.

FIG. 8 shows a diagram of a system including a device that supports procedures for SDT in accordance with one or more aspects of the present disclosure.

FIGS. 9 through 13 show flowcharts illustrating methods that support procedures for SDT in accordance with one or more aspects of the present disclosure.

### DETAILED DESCRIPTION

Wireless networks may utilize small data transmission (SDT) to support data or signaling transmissions while a user equipment (UE) remains in an inactive state. The SDT may include the UE transmitting a small amount of data during a random-access channel (RACH) procedure, such as in a first message during the RACH procedure. The UE may be configured to perform SDT during the RACH procedure (e.g., random-access SDT (RA-SDT)) or using Type 1 configured grant (CG) resources (e.g., CG-SDT). However, such networks limit the SDT techniques to, for example, a single bandwidth part (BWP), to either RA-SDT or CG-SDT, and other limitations that generally limit the flexibility, power, and spectral efficiency of the SDT techniques.

Accordingly, the described techniques provide for improved SDT techniques that improve the flexibility, power, and spectral efficiency. For example, one aspects of the described techniques may provide for a UE to initiate an SDT procedure via contention-free random access (CFRA) or contention-based random access (CBRA) resources and continue the SDT procedure after the RACH procedure using Type-1 or Type-2 CG resources. This may include a network entity (e.g., a UE) transmitting or otherwise providing SDT initialization information in a first message of a random-access procedure. The SDT initialization information may carry or otherwise convey an indication of an identification of the UE for association with the SDT procedure. The UE may transmit SDT data after the RACH procedure as part of the SDT procedure. The UE may transmit the additional SDT after the RACH procedure using the Type-1 or Type-2 CG resources.

Additionally, or alternatively, aspects of the described techniques may provide for SDT initialization where the subsequent SDT being configured in the same or in different BWPs. The network entity (e.g., a UE) may transmit or otherwise provide the SDT initialization information during the RACH procedure and via a first BWP. The SDT initialization information may indicate the identification of the network entity for association with the SDT procedure. The UE may receive or otherwise obtain a BWP trigger that initiates or otherwise triggers the UE to switch from the first BWP to a second BWP for the SDT procedure. Accordingly, the UE may transmit SDT data in the second BWP as part of the SDT procedure in response to the BWP trigger. The UE may again transmit the SDT data using Type-1 or Type-2 CG resources.

Aspects of the disclosure are initially described in the context of wireless communications systems. Aspects of the disclosure are further illustrated by and described with reference to apparatus diagrams, system diagrams, and flowcharts that relate to procedures for small data transmission.

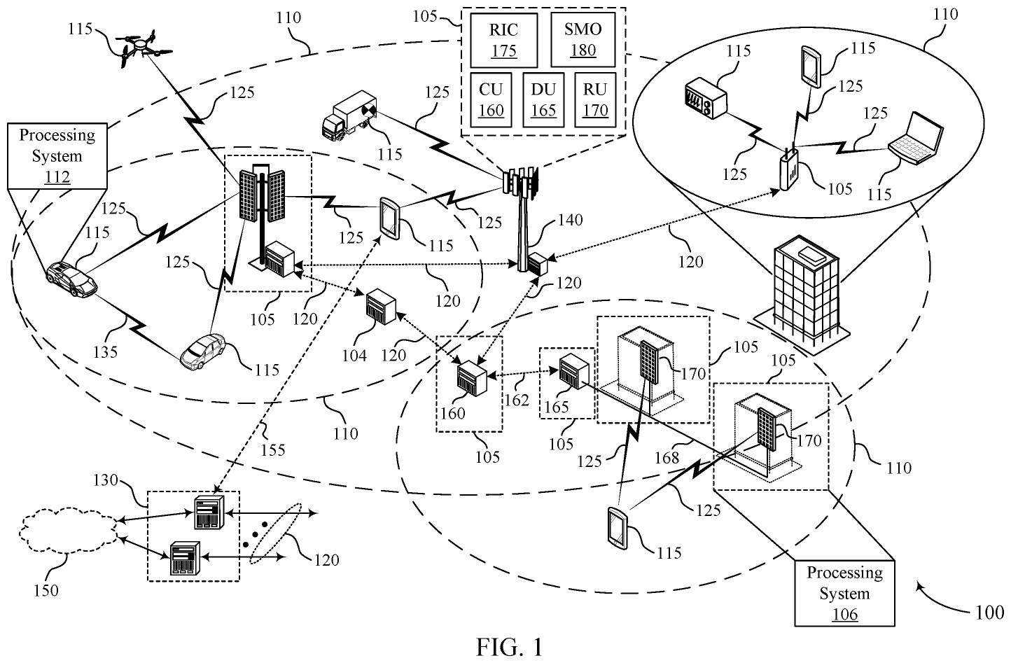

FIG. 1 shows an example of a wireless communications system 100 that supports procedures for SDT in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various aspects, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may transmit SDT initialization information in a first message of a random-access procedure, wherein the SDT initialization information indicates an identification of the network entity (e.g., the UE 115) for association with an SDT procedure. The UE 115 may transmit SDT data after completion of the random-access procedure and as part of the SDT procedure, wherein transmission of the SDT data is over a configured grant resource set.

A UE 115 may transmit SDT initialization information in a first message of a random-access procedure via a first BWP, wherein the SDT initialization information indicates an identification of the network entity (e.g., the UE 115) for association with an SDT procedure. The UE 115 may receive a trigger for BWP switching during the SDT procedure, wherein the trigger for BWP switching initiates a switch from the first BWP to a second BWP for the SDT procedure. The UE 115 may transmit SDT data in the second BWP as part of the SDT procedure in accordance with the trigger for BWP switching, wherein transmission of the SDT data is over a configured grant resource set.

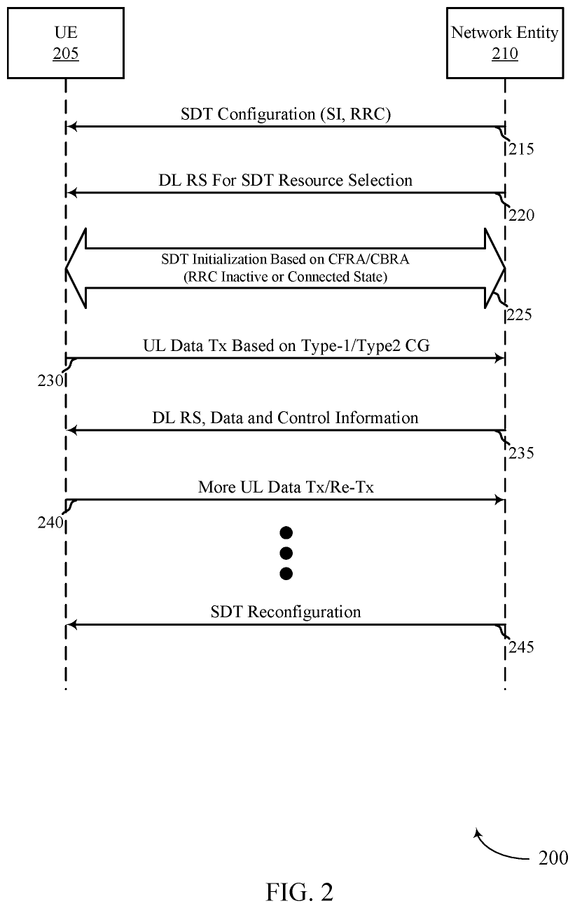

FIG. 2 shows an example of a swim diagram 200 that supports procedures for SDT in accordance with one or more aspects of the present disclosure. Swim diagram 200 may implement aspects of wireless communications system 100. Aspects of swim diagram 200 may be implemented at or implemented by a UE 205 and a network entity 210, which may be examples of the corresponding devices described herein.

Wireless networks may support SDT operations. The small data transmission may include data, signaling, or other control information from the UE 205 while the UE 205 operates in an inactive state (e.g., an RRC inactive or idle state or mode). These techniques improve power saving operations and reduce signaling overhead for the UE 205 and for the network entity 210. For a UE-initiated SDT procedure, the SDT resources are generally configured in the initial BWP. That is, the network entity 210 may configure the UE 205 with an initial uplink BWP (and an initial downlink BWP) via RRC signaling. The initial uplink BWP may include the SDT resources available for the UE 205 to use for the SDT procedure while in the inactive state. The SDT resources are generally either random-access SDT resources available as part of a RACH procedure with the network entity 210 or CG SDT resources where the SDT resources are (pre) configured for the UE 205 via RRC signaling.

When the SDT resources are RACH based resources (e.g., RA-SDT), the network entity 210 may configure the UE 205 with one or both of a two-step or a four-step contention based random-access procedure resource set that includes the RA-SDT resources. For example, the RA-SDT resources may be used for the UE 205 to send the small data to the network entity 210 in a message 3 (Msg3) of a four-step RACH procedure. The RA-SDT resources may be used for the UE 205 to send the small data to the network entity 210 in a first uplink message (e.g., MsgA) of a two-step RACH procedure.

When the SDT resources are CG-based SDT resources (e.g., CG-SDT), the network entity 210 may configure the UE 205 with Type-1 CG resources to be used for an SDT procedure via dedicated signaling, such as in an RRC release message. The Type-1 CG resources are generally associated the uplink resources being configured that are activated without further signaling (e.g., the uplink SDT resources are available to the UE 205 once configured).

However, wireless networks generally impose various limitations on the SDT procedure. One limitation is that when the network configures both RA-SDT and CG-SDT resources in the initial BWP, the UE is required to perform SDT type selection (e.g., to select either RA-SDT or CG-SDT) before initiating the SDT procedure. Once a given SDT type is selected, the UE is not allowed to switch the type of SDT procedure (e.g., from a RA-SDT to a CG-SDT, or vice versa). Another limitation may be that the SDT resources are configured on the initial BWP and cannot be configured on a non-initial BWP. Moreover, a CG-SDT procedure cannot be initiated by the UE unless the UE has a valid timing advance. Additionally, wireless networks generally only permit a Type-1 CG-SDT procedure. The CG-SDT resources may be configured while the UE is in the connected state without prior knowledge of the UE's status (e.g., power headroom (PHR), beam failure recover (BFR), and other statuses of the UE) or of the traffic profile of the UE (e.g., an arrival time of the first message, the traffic pattern, and more). Due to such restrictions or limitations imposed by such networks, the flexibility, power, and spectral efficiency of the SDT procedure is compromised.

Accordingly, aspects of the techniques described herein mitigate such issues imposed by the limitations and restrictions. Instead, the described techniques include new SDT procedures that may be based on hybrids of RA-SDT and CG-SDT. The described techniques may result in a better tradeoff in terms of power efficiency, resource utilization efficiency, service continuity, and scheduling flexibility for SDT while the UE 205 is operating in both the inactive state or in the active state. The described techniques further reduce the complexity of the UE 205 for SDT implementation. Aspects of the described techniques may be applied in various wireless networks, such as in sixth generation (6G) networks, voice communication-based networks, non-terrestrial networks (NTNs), gaming, data collection and fusion for artificial intelligence or machine learning systems, sensing networks, and the like. Swim diagram 200 illustrates one non-limiting example of aspects of the described techniques. In some aspects, swim diagram 200 may support a 6G UE initiating an SDT procedure via CFRA or CBRA resources in either an inactive state or in a connected state.

At 215, the network entity 210 may transmit or otherwise provide (and the UE 205 may receive or otherwise obtain) SDT configuration information. In some aspects, the SDT configuration may indicate or otherwise identify CFRA resources for a physical random-access channel (PRACH). The PRACH resources for CFRA may be configured using dedicated RRC signaling (e.g., in an RRC release message). The PRACH resources for CFRA may be indicated using other signaling, such as in a downlink control information (DCI) or medium access control-control element (MAC-CE) signaling (e.g., CFRA ordered by PDCCH or MAC-CE). Accordingly, the UE 205 may receive an indication of a random-access resource set for the random-access procedure.

In some aspects, the SDT configuration may indicate or otherwise identify CBRA resources for the UE 205. The PRACH resources for CBRA may be configured using system information (SI), MAC-CE, DCI, or RRC signaling. The PRACH resources for CBRA may be indicated or otherwise identified using an RRC release message to the UE 205.

At 220, the UE 205 may monitor for and receive a downlink reference signal (DL-RS). The DL-RS may be used by the UE 205 to identify or otherwise determine the resources to be used for an SDT procedure. For example, the UE 205 may measure various channel performance metrics for the channel between the UE 205 and the network entity 210 based on the DL-RS. The UE 205 may use the results of the measurements to identify available resources to be used for the SDT procedure. For example, the UE 205 may identify CBRA or CFRA PRACH resources according to the results of the channel performance metric measurements.

Accordingly, at 225 the UE 205 may initiate the SDT procedure with the network entity 210. For example, the UE 205 may begin a RACH procedure with the network entity 210 by transmitting or otherwise providing a RACH message (e.g., a RACH preamble). This may include the UE 205 transmitting or otherwise providing (and the network entity 210 receiving or otherwise obtaining) SDT initialization information in a first message of a random-access procedure. In some aspects, the SDT initialization information may carry or otherwise convey an indication of an identifier for the UE 205 for association with an SDT procedure. In some aspects, the UE 205 may transmit the SDT initialization information to the network entity 210 while the UE 205 is operating in an RRC active state or operating in an RRC inactive state. That is, the UE 205 may use the RACH procedure to communicate small data with the network entity 210 while operating in the RRC active state. In some aspects, the transmission of the SDT initialization information may initiate or start the SDT procedure with the network entity 210.

For example, if dedicated PRACH resources (e.g., RACH occasion (RO) or a RACH preamble group) are allocated or otherwise configured for the UE 205 (e.g., via the SDT configuration), the initial PUSCH transmission (e.g., the SDT initialization information) for the SDT procedure may include the identifier of the UE 205 (e.g., a common control channel (CCCH) message indicating the C-RNTI of the UE 205). If the RACH procedure is a two-step CBRA or CFRA RACH procedure, the SDT initialization information may be sent in a first message corresponding to the MsgA of the RACH procedure. If the RACH procedure is a four-step CBRA or CFRA RACH procedure, the SDT initialization information may be sent in a first message corresponding to the Msg3 of the RACH procedure. Accordingly, when the random-access resource set includes dedicated SDT resources for the SDT procedure, the identification of the UE 205 may be indicated in the SDT initialization information based on the dedicated SDT resources being configured.

If dedicated PRACH resources are not allocated or otherwise configured for the UE 205, the initial PUSCH transmission (e.g., the SDT initialization information) for the SDT procedure (e.g., Msg3 of the four-step or MsgA of the two-step CBRA or CFRA RACH procedure) may include or otherwise convey a cause or trigger event for the random-access procedure (e.g., a “request for SDT”) in addition to the identifier of the UE 205. Accordingly, when dedicated SDT resources are not configured (e.g., non-dedicated SDT resources), the UE 205 may indicate a request for the SDT procedure in the first message (e.g., in the SDT initialization information) based on the dedicated SDT resources not being configured.

Accordingly, the UE 205 may transmit the SDT initialization information in the first message (e.g., Msg3 or MsgA) of the random-access procedure. In some aspects, the first message may include at least a portion of the small data that the UE 205 is communicating during the SDT procedure. For example, the first message may carry or otherwise convey an indication of a status report or assistance information message in the first message during the random-access procedure. In some examples, the status report or the assistance information message from the UE 205 may carry or otherwise convey any combination of a buffer status report (BSR), a power headroom (PHR), mobility information, a CSI report, information for beam management, traffic profile information, power saving requirements.

At 230, the UE 205 may transmit or otherwise provide (and the network entity 210 may receive or otherwise obtain) uplink data after the random-access procedure has completed. For example, the UE 205 may transmit SDT data as part of the SDT procedure once the random-access procedure has finished. After successful completion of the CFRA or the CBRA PRACH procedure, the UE 205 may proceed with SDT communications (e.g., in the uplink data) over CG resources (e.g., Type-1 CG resources or using Type-2 CG resources). In the situation where the first message indicating the SDT initialization information includes the request for the SDT procedure, the request may serve to activate the CG resources. Accordingly, the UE 205 may transmit an additional status report or assistance information message (e.g., the uplink data) using the CG resource set during the SDT procedure. In this example, the UE 205 may transmit in the additional status report or assistance information message one or more of the BSR, the PHR, the measurements associated with the mobility procedures, the CSI report, beam management information, the traffic profile, and power saving requirements. The uplink data transmission based on the Type-1 or Type-2 CG resource set may include data from the user or control plane, updates to the UE status report or the UE assistance information.

At 235, the network entity 210 may again transmit additional DL-RS, data, or control information to the UE 205 according to the SDT procedure. For example, the SDT procedure may be used to indicate the UE status report or assistance information messages that triggers ongoing communications with the network entity 210. The DL-RS, data, and control information may include a grant for retransmission of uplink data, a modified system information (SI), or a notification that the SI has been updated. At 240, the UE 205 may perform additional uplink data transmissions or retransmissions to the network entity 210. This process may continue until the UE 205 is configured with new or updated SDT configuration information at 245. For example, the (re) configuration of the SDT may include or otherwise identify new configurations for the SDT resources, switching from CG to dynamic grant, release of SDT resources, or other configuration information related to random-access or SDT operations.

In some aspects, the described SDT procedure based on hybrids of CFRA using a CG (Type-1 or Type-2) resource set may reduce the latency when compared to legacy RA-SDT. The described techniques may improve the resource utilization efficiency over legacy CG-SDT (limited to Type-1 only) since the CG resource set can be configured or activated “on-demand” based on the “request for SDT” sent in the CFRA resource set (e.g., in the first message of the random-access procedure). Additionally, the restrictions on the UE 205 having a valid timing advance to use CG-SDT can be relaxed since the UE 205 may obtain or otherwise identify its timing advance in the random-access procedure upon SDT initialization and report “stationary or low mobility” during SDT initialization to facilitate the CG resource set configuration.

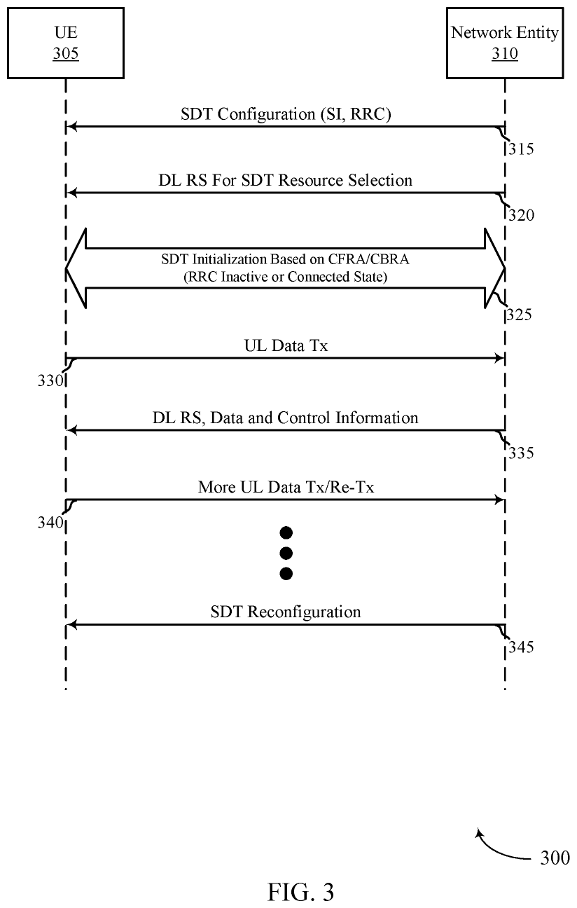

FIG. 3 shows an example of a swim diagram 300 that supports procedures for SDT in accordance with one or more aspects of the present disclosure. Swim diagram 300 may implement aspects of wireless communications system 100. Aspects of swim diagram 300 may be implemented at or implemented by a UE 305 and a network entity 310, which may be examples of the corresponding devices described herein.

As discussed above, some wireless networks may impose restrictions or limitations on a UE wishing to perform an SDT procedure. One limitation may be that the SDT resources are configured on the initial BWP and cannot be configured on a non-initial BWP. However, swim diagram 300 illustrates a non-limiting example of techniques for the SDT procedure to be initiated on the initial BWP of the UE 305 and then continue on a non-initial BWP. In particular, swim diagram 300 illustrates an example where the resource set for the SDT initialization and subsequent small data transmissions can be configured in the same or in different BWPs.

At 315, the network entity 310 may transmit or otherwise provide (and the UE 305 may receive or otherwise obtain) SDT configuration information. In some aspects, the SDT configuration may indicate or otherwise identify CFRA resources, CBRA resources, or both resource sets for a PRACH. The PRACH resources for CFRA or CBRA may be configured using dedicated RRC signaling (e.g., in an RRC release message). The PRACH resources for CFRA or CBRA may be indicated using other signaling, such as in a DCI or MAC-CE signaling. Accordingly, the UE 305 may receive an indication of a CFRA resource set and a CBRA resource set for the random-access procedure.

In some aspects, the SDT configuration may indicate or otherwise identify CFRA resources for the UE 305. For SDT initialization, a two-step CFRA and a four-step CFRA can be configured at the same time and in the initial BWP or in a non-initial BWP associated with the SDT procedure.

At 320, the UE 305 may monitor for and receive a DL-RS. The DL-RS may be used by the UE 305 to identify or otherwise determine the resources to be used for an SDT procedure. For example, the UE 305 may measure various channel performance metrics for the channel between the UE 305 and the network entity 310 based on the DL-RS. The UE 305 may use the results of the measurements to identify available resources to be used for the SDT procedure. For example, the UE 305 may identify CBRA or CFRA PRACH resources according to the results of the channel performance metric measurements.

Accordingly, at 325 the UE 305 may initiate the SDT procedure with the network entity 310. For example, the UE 305 may begin a RACH procedure with the network entity 310 by transmitting or otherwise providing a RACH message (e.g., a RACH preamble). This may include the UE 305 transmitting or otherwise providing (and the network entity 310 receiving or otherwise obtaining) SDT initialization information in a first message of a random-access procedure. The SDT initialization information may be transmitted in a CFRA resource set or in a CBRA resource set, depending on the resources configured for the UE 305. In some aspects, the SDT initialization information may carry or otherwise convey an indication of an identifier for the UE 305 for association with an SDT procedure. In some aspects, the UE 305 may transmit the SDT initialization information to the network entity 310 while the UE 305 is operating in an RRC active state or operating in an RRC inactive state. That is, the UE 305 may use the RACH procedure to communicate small data with the network entity 310 while operating in the RRC active state. In some aspects, the transmission of the SDT initialization information may initiate or start the SDT procedure with the network entity 310.

In some aspects, the first message carrying or otherwise conveying an indication of the SDT initialization information may be transmitted in a first BWP. The first BWP may be an initial BWP or may be a non-initial BWP.

The UE 305 may receive or otherwise obtain (and the network entity 310 may transmit or otherwise provide for output) a trigger for BWP switching during the SDT procedure. The trigger for BWP switching may initiate a switch from the first BWP to a second BWP for the SDT procedure. That is, the second BWP may be different from the first BWP that the SDT initialization information is provided in. The second BWP may be a non-initial BWP or an initial BWP, respectively. The trigger for BWP switching may be received in an RRC message, a MAC-CE, or a DCI message. That is, the BWP switching may be triggered by a DCI, a MAC-CE, or by RRC signaling during the SDT procedure. For example, the UE 305 may leverage the random-access resources configured in the initial BWP for SDT initialization and then switch to a non-initial BWP to continue the SDT procedure. The UE 305 may continue the SDT procedure using a CG resource set (e.g., either Type-1 CG resources or Type-2 CG resources).

In some aspects, the UE 305 may transmit the uplink data using or based on CFRA resources, on CBRA resources, or on both when both are configured. For example, when the resources for both CFRA and CBRA are configured for SDT initialization, the UE 305 may prioritize the CFRA resources for SDT initialization. For example, the UE 305 may receive an indication of a CFRA resource set and a CBRA resource set. The UE 305 may transmit the SDT initialization information in either the CFRA resource set or the CBRA resource set. In some examples, this prioritization may be based on whether the channel performance measurements of the DL-RS in the serving cell are above (e.g., satisfy) a threshold and the timer for the CFRA resources is still running. That is, the UE 305 may prioritize the CFRA resource set for the SDT initialization information transmission based on the channel performance metric satisfying a channel performance threshold or based on an expiration status of a timer associated with the CFRA resource set. The channel performance metrics may correspond to any of a reference signal receive power (RSRP), a reference signal receive quality (RSRQ), a signal-to-noise ratio (SNR), or other metrics generally associated with the channel performance as measured using the DL-RS.

However, the UE 305 may prioritize the CBRA resource set for the SDT initialization information transmission based on the channel performance metric failing to satisfy the channel performance metric or based on the expiration status of the timer associated with the CFRA resource set. That is, the UE 305 may attempt to use the CBRA resource set if the CFRA timer expires or if the measurements of the DL-RS are below the channel performance threshold for the CFRA resource set.

However, in some examples only the CBRA resource set is configured for the UE 305. The CBRA resource set may include either a two-step or a four-step random-access procedure. That is, the CFRA resource set may not be configured for the UE 305 by the network entity 310, in some examples. However, the CBRA resource set may include resources for both the two-step random-access procedure and the four-step random access procedure.

The UE 305 may prioritize the two-step CBRA resource set for SDT initialization information transmission, in some examples. That is, the UE 305 may prioritize the two-step random-access procedure over the four-step random-access procedure for the SDT initialization information. In this example, prioritizing the two-step random-access procedure may be based on the channel performance metrics satisfying the channel performance threshold, based on the non-expiration status (e.g., the timer is still running) of the timer associated with the CBRA resource set, or based on a message retransmission counter being below a retransmission count threshold. That is, the UE 305 may prioritize the two-step CBRA random-access procedure if the measurements of the DL-RS of the serving cell are above (e.g., satisfy) the threshold, and if the timer for the two-step CBRA resources is running or if the counter of MsgA retransmissions is below a threshold.

Otherwise, the UE 305 may prioritize the four-step random access procedure over the two-step random-access procedure for transmission of the SDT initialization information. That is, the UE 305 may prioritize (e.g., select) the four-step CBRA resource set for the random-access procedure if the channel performance metric fails to satisfy the channel performance threshold, based on expiration of the CBRA resource set timer, or based on the retransmission counter reaching the retransmission count threshold.

At 330, the UE 305 may transmit or otherwise provide for output (and the network entity 310 may receive or otherwise obtain) more uplink data transmissions during the SDT procedure. For example, the UE 305 may transmit the uplink data during the SDT procedure and using a CG resource set. The CG resource set may be a Type-1 CG resource set or a Type-2 CG resource set. The UE 305 may transmit the uplink data (e.g., the SDT data during the SDT procedure) in the second BWP in accordance with the trigger for BWP switching.

At 335, the network entity 310 may again transmit additional DL-RS, data, or control information to the UE 305 according to the SDT procedure. For example, the SDT procedure may be used to indicate the UE status report or assistance information messages that triggers ongoing communications with the network entity 310. The DL-RS, data, and control information may include a grant for retransmission of uplink data, a modified SI, or a notification that the SI has been updated. At 340, the UE 305 may perform additional uplink data transmissions or retransmissions to the network entity 310. This process may continue until the UE 305 is configured with new or updated SDT configuration information at 345. For example, the (re) configuration of the SDT may include or otherwise identify new configurations for the SDT resources, switching from CG to dynamic grant, release of SDT resources, or other configuration information related to random-access or SDT operations.

In some aspects, allowing distributed SDT resource configuration and BWP switching during the SDT procedure may improve traffic offloading, scheduling flexibility, and coexistence with different UE or service types.

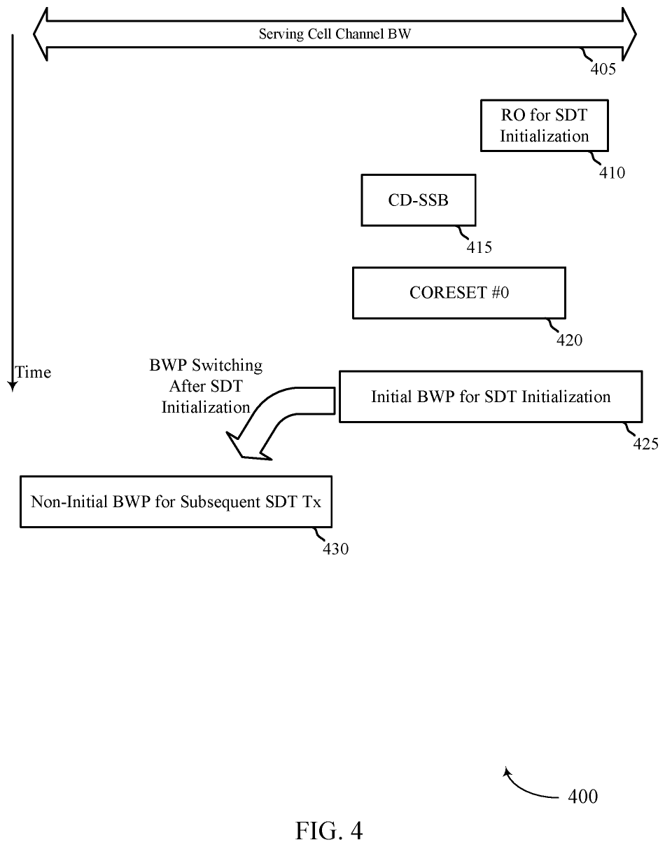

FIG. 4 shows an example of a bandwidth configuration 400 that supports procedures for SDT in accordance with one or more aspects of the present disclosure. Bandwidth configuration 400 may implement aspects of wireless communications system 100 or aspects of swim diagram 300. Aspects of bandwidth configuration 400 may be implemented at or implemented by a UE and a network entity, which may be examples of the corresponding devices described herein.

As discussed above, aspects of the techniques described herein provide for SDT initialization in a first BWP and continuing the SDT procedure in a second BWP that is different from the first BWP. For example, the UE and the network entity may be communicating within a bandwidth 405 that generally defines the bandwidth of the channel that the serving cell (e.g., the network entity) manages. The network entity may have the bandwidth 405 available for various communications with UE operating within its coverage area. The network entity may schedule or otherwise allocate a RACH occasion 410 for the UE. The RACH occasion 410 may generally identify the resources (e.g., the frequency resources, the time resources, the spatial resources, or other resources) that is available for the UE to initiate a random-access procedure.

The network entity may also have a portion of the bandwidth 405 allocated to a cell defining SSB (CD-SSB) allocated for SSB 415 transmissions to UE within its coverage area. The SSB 415 may generally carry or otherwise convey a synchronization signal (e.g., a primary synchronization signal (PSS) and a secondary synchronization signal (SSS)) along with a physical broadcast channel (PBCH) signal, such as a PBCH DMRS and PBCH (data). This information may be used by the UE for various functions, such as cell identification, synchronization, and additional information. The network entity may also have a portion of the bandwidth 405 allocated to a CORESET 420 that generally defines the default CORESET that UE monitors for PDCCH reception (e.g., DCI reception) from the network entity.

The network entity may also have a portion of the bandwidth 405 allocated to an initial BWP 425 that generally defines the CBRA resource set, the CFRA resource set, or both resource sets. For example, the network entity may transmit or otherwise provide an indication of the CFRA resource set, the CBRA resource set, or both resource sets to the UE. The UE may initiate a random-access procedure with the network entity using the initial BWP 425. For example, the UE may transmit or otherwise provide (and the network entity may receive or otherwise obtain) SDT initialization information in a first message of the random-access procedure. The SDT initialization information may be transmitted to the network entity in a first BWP. The first BWP in this example may correspond to the initial BWP 425.

However, the network entity may transmit or otherwise provide a trigger for BWP switching to the UE that initiates a switch from the first BWP to a second BWP for the SDT procedure. The trigger for BWP switching may be transmitted in a DCI, a MAC-CE, or in other signaling from the network entity. The UE may switch from the first BWP (e.g., the initial BWP 425) to the second BWP (e.g., the non-initial BWP 430, in this example) based on the trigger for BWP switching. The UE may transmit or otherwise provide SDT data to the network entity in the second BWP as part of the SDT procedure based on the trigger for BWP switching. That is, the UE may initiate the SDT procedure in the initial BWP 425 and then continue the SDT procedure in the non-initial BWP 430. This technique may improve flexibility and resource utilization for the SDT procedure between the UE and the network entity.

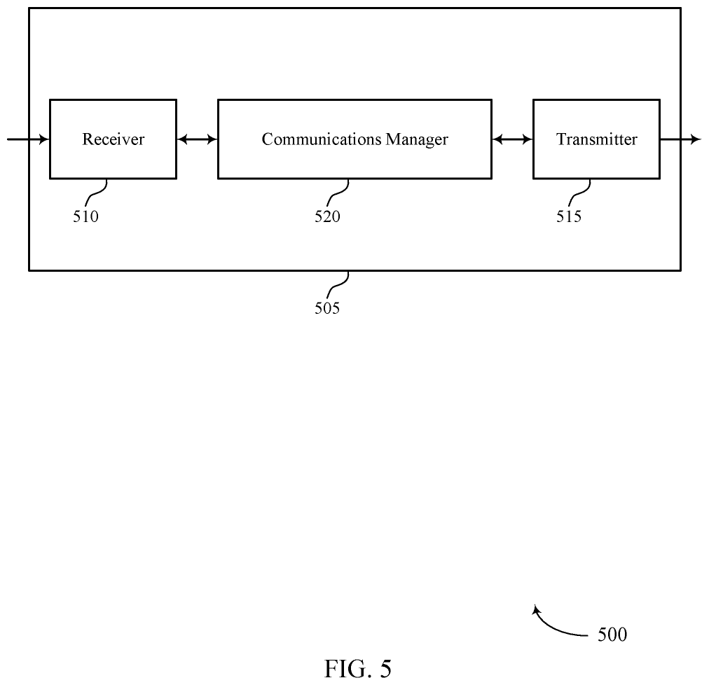

FIG. 5 shows a block diagram 500 of a device 505 that supports procedures for SDT in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to procedures for SDT). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to procedures for SDT). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of procedures for SDT as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting SDT initialization information in a first message of a random-access procedure, where the SDT initialization information indicates an identification of the network entity for association with an SDT procedure. The communications manager 520 is capable of, configured to, or operable to support a means for transmitting SDT data after completion of the random-access procedure and as part of the SDT procedure, where transmission of the SDT data is over a configured grant resource set.

Additionally, or alternatively, the communications manager 520 may support wireless communications in accordance with examples as disclosed herein. For example, the communications manager 520 is capable of, configured to, or operable to support a means for transmitting SDT initialization information in a first message of a random-access procedure via a first BWP, where the SDT initialization information indicates an identification of the network entity for association with an SDT procedure. The communications manager 520 is capable of, configured to, or operable to support a means for receiving a trigger for BWP switching during the SDT procedure, where the trigger for BWP switching initiates a switch from the first BWP to a second BWP for the SDT procedure. The communications manager 520 is capable of, configured to, or operable to support a means for transmitting SDT data in the second BWP as part of the SDT procedure in accordance with the trigger for BWP switching, where transmission of the SDT data is over a configured grant resource set.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for improved SDT procedures while a UE is operating in RRC active or RRC inactive states. The SDT procedure may be initiated in a first BWP and then continue in a second BWP in response to a BWP switching trigger.

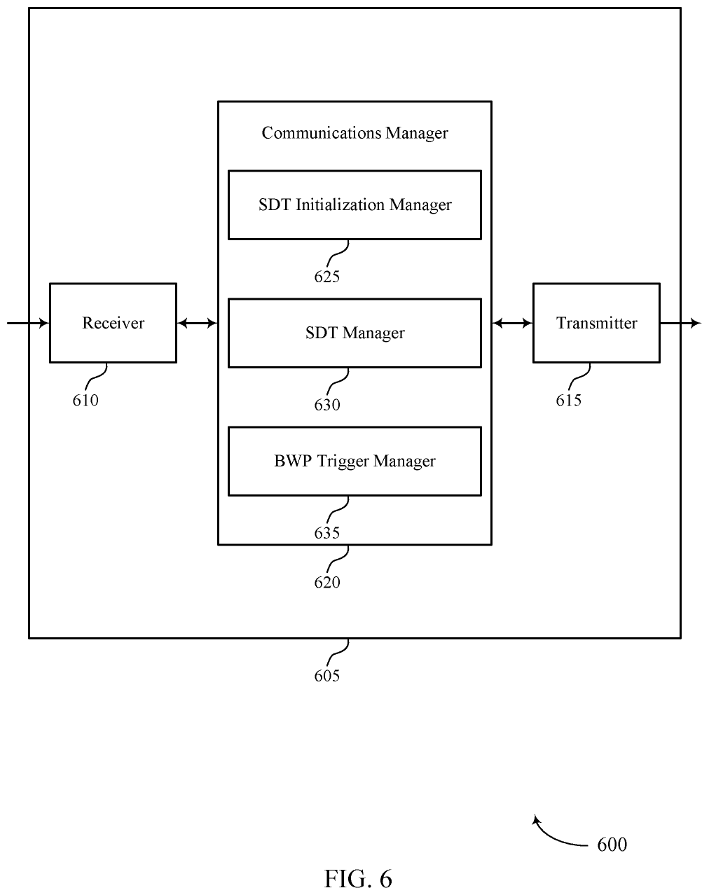

FIG. 6 shows a block diagram 600 of a device 605 that supports procedures for SDT in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to procedures for SDT). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to procedures for SDT). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of procedures for SDT as described herein. For example, the communications manager 620 may include an SDT Initialization manager 625, an SDT manager 630, a BWP trigger manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SDT Initialization manager 625 is capable of, configured to, or operable to support a means for transmitting SDT initialization information in a first message of a random-access procedure, where the SDT initialization information indicates an identification of the network entity for association with an SDT procedure. The SDT manager 630 is capable of, configured to, or operable to support a means for transmitting SDT data after completion of the random-access procedure and as part of the SDT procedure, where transmission of the SDT data is over a configured grant resource set.

Additionally, or alternatively, the communications manager 620 may support wireless communications in accordance with examples as disclosed herein. The SDT Initialization manager 625 is capable of, configured to, or operable to support a means for transmitting SDT initialization information in a first message of a random-access procedure via a first BWP, where the SDT initialization information indicates an identification of the network entity for association with an SDT procedure. The BWP trigger manager 635 is capable of, configured to, or operable to support a means for receiving a trigger for BWP switching during the SDT procedure, where the trigger for BWP switching initiates a switch from the first BWP to a second BWP for the SDT procedure. The SDT manager 630 is capable of, configured to, or operable to support a means for transmitting SDT data in the second BWP as part of the SDT procedure in accordance with the trigger for BWP switching, where transmission of the SDT data is over a configured grant resource set.

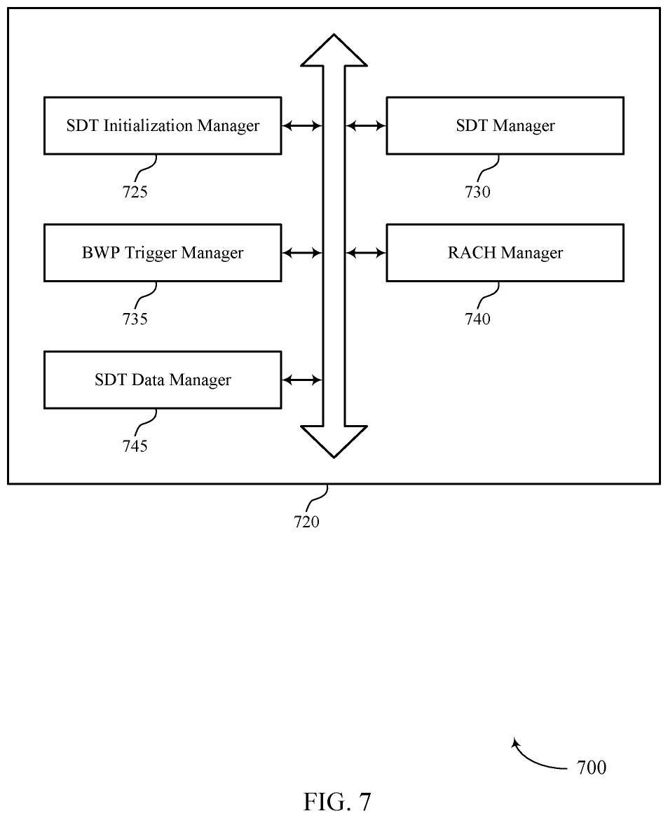

FIG. 7 shows a block diagram 700 of a communications manager 720 that supports procedures for SDT in accordance with one or more aspects of the present disclosure. The communications manager 720 may be an example of aspects of a communications manager 520, a communications manager 620, or both, as described herein. The communications manager 720, or various components thereof, may be an example of means for performing various aspects of procedures for SDT as described herein. For example, the communications manager 720 may include an SDT Initialization manager 725, an SDT manager 730, a BWP trigger manager 735, a RACH manager 740, an SDT data manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SDT Initialization manager 725 is capable of, configured to, or operable to support a means for transmitting SDT initialization information in a first message of a random-access procedure, where the SDT initialization information indicates an identification of the network entity for association with an SDT procedure. The SDT manager 730 is capable of, configured to, or operable to support a means for transmitting SDT data after completion of the random-access procedure and as part of the SDT procedure, where transmission of the SDT data is over a configured grant resource set.

In some examples, the RACH manager 740 is capable of, configured to, or operable to support a means for receiving an indication of a random-access resource set for the random-access procedure, where the SDT initialization information is transmitted in the random-access resource set. In some examples, the random-access resource set includes dedicated SDT resources for the SDT procedure. In some examples, the identification of the network entity is indicated in the SDT initialization information based on the random-access resource set that includes the dedicated SDT resources for the SDT procedure.

In some examples, the RACH manager 740 is capable of, configured to, or operable to support a means for indicating a request for the SDT procedure in the first message based on the random-access resource set that includes the non-dedicated SDT resources for the SDT procedure. In some examples, the random-access resource set is received in an RRC release message, a DCI message, a system information message, or a MAC-CE. In some examples, the random-access resource set includes a contention-free random-access resource set or a contention-based random-access resource set.

In some examples, the RACH manager 740 is capable of, configured to, or operable to support a means for indicating a request for the SDT procedure in the first message, where the request for the SDT procedure activates the configured grant resource set.

In some examples, the SDT data manager 745 is capable of, configured to, or operable to support a means for transmitting a status report or an assistance information message in the first message during the random-access procedure. In some examples, the SDT data manager 745 is capable of, configured to, or operable to support a means for transmitting an additional status report or an additional assistance information message using the configured grant resource set and during the SDT procedure. In some examples, the additional status report or the additional assistance information message include one or more of a BSR, a PHR, measurements associated with mobility procedures, a CSI report, beam management information, a traffic profile, a power saving requirement, or any combination thereof. In some examples, the SDT initialization information is transmitted while the network entity is in an RRC active state or in an RRC inactive state.

In some examples, the configured grant resource set includes Type-1 CG resources or Type-2 configured grant resources. In some examples, transmission of the SDT initialization information initiates the SDT procedure. In some examples, the network entity includes a UE.

Additionally, or alternatively, the communications manager 720 may support wireless communications in accordance with examples as disclosed herein. In some examples, the SDT Initialization manager 725 is capable of, configured to, or operable to support a means for transmitting SDT initialization information in a first message of a random-access procedure via a first BWP, where the SDT initialization information indicates an identification of the network entity for association with an SDT procedure. The BWP trigger manager 735 is capable of, configured to, or operable to support a means for receiving a trigger for BWP switching during the SDT procedure, where the trigger for BWP switching initiates a switch from the first BWP to a second BWP for the SDT procedure. In some examples, the SDT manager 730 is capable of, configured to, or operable to support a means for transmitting SDT data in the second BWP as part of the SDT procedure in accordance with the trigger for BWP switching, where transmission of the SDT data is over a configured grant resource set.

In some examples, the RACH manager 740 is capable of, configured to, or operable to support a means for receiving an indication of a CFRA resource set and a CBRA resource set for the random-access procedure, where the SDT initialization information is transmitted in the contention-free random-access resource set or the contention-based random-access resource set.

In some examples, the RACH manager 740 is capable of, configured to, or operable to support a means for prioritizing the CFRA resource set over the CBRA resource set for transmission of the SDT initialization information based on a channel performance metric satisfying a channel performance threshold or based on a non-expiration status of a timer associated with the CFRA resource set.

In some examples, the RACH manager 740 is capable of, configured to, or operable to support a means for prioritizing the CBRA resource set over the CFRA resource set for transmission of the SDT initialization information based on a channel performance metric failing to satisfy a channel performance threshold or based on an expiration status of a timer associated with the CFRA resource set.

In some examples, the RACH manager 740 is capable of, configured to, or operable to support a means for receiving an indication of a CBRA resource set for the random-access procedure, where the CBRA resource set includes a two-step random-access procedure or a four-step random-access procedure.

In some examples, the RACH manager 740 is capable of, configured to, or operable to support a means for prioritizing the two-step random-access procedure over the four-step random-access procedure for transmission of the SDT initialization information based on a channel performance measurement that satisfies a channel performance threshold, based on a non-expiration status of a timer associated with the CBRA resource set, or based on a message retransmission counter that is below a retransmission count threshold.

In some examples, the RACH manager 740 is capable of, configured to, or operable to support a means for prioritizing the four-step random-access procedure over the two-step random-access procedure for transmission of the SDT initialization information based on a channel performance measurement that fails to satisfy a channel performance threshold, based on an expiration status of a timer associated with the CBRA resource set, or based on a message retransmission counter that has reached a retransmission count threshold.

In some examples, the trigger for BWP switching is received in an RRC message, a MAC-CE, or a DCI message. In some examples, the configured grant resource set includes Type-1 configured grant resources or Type-2 configured grant resources. In some examples, transmission of the SDT initialization information initiates the SDT procedure. In some examples, the network entity includes a UE.

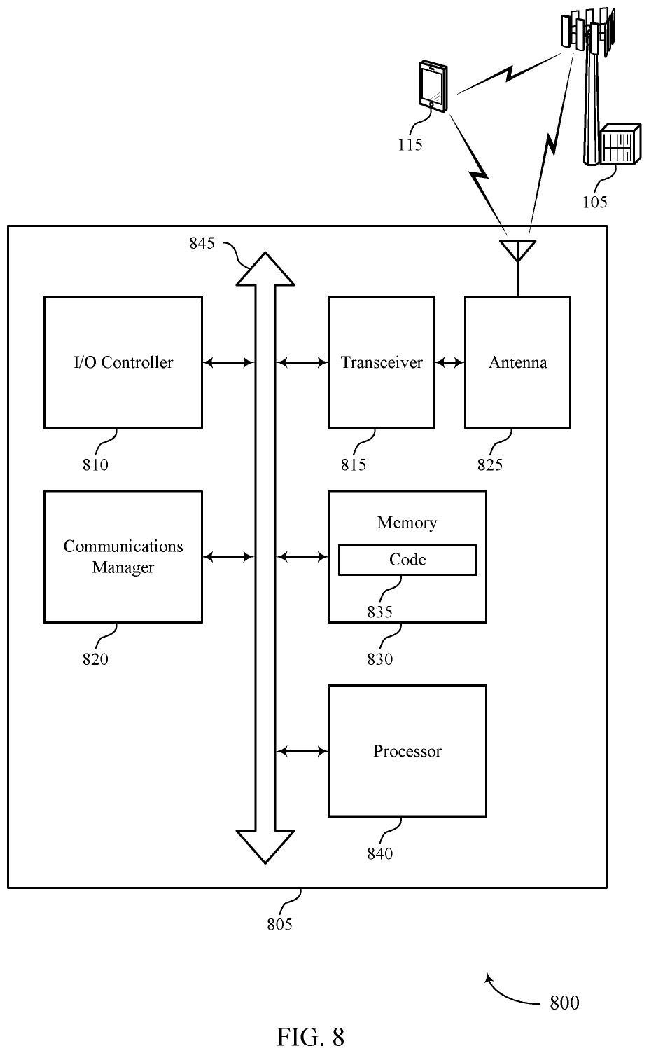

FIG. 8 shows a diagram of a system 800 including a device 805 that supports procedures for SDT in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting procedures for SDT). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting SDT initialization information in a first message of a random-access procedure, where the SDT initialization information indicates an identification of the network entity for association with an SDT procedure. The communications manager 820 is capable of, configured to, or operable to support a means for transmitting SDT data after completion of the random-access procedure and as part of the SDT procedure, where transmission of the SDT data is over a configured grant resource set.

Additionally, or alternatively, the communications manager 820 may support wireless communications in accordance with examples as disclosed herein. For example, the communications manager 820 is capable of, configured to, or operable to support a means for transmitting SDT initialization information in a first message of a random-access procedure via a first BWP, where the SDT initialization information indicates an identification of the network entity for association with an SDT procedure. The communications manager 820 is capable of, configured to, or operable to support a means for receiving a trigger for BWP switching during the SDT procedure, where the trigger for BWP switching initiates a switch from the first BWP to a second BWP for the SDT procedure. The communications manager 820 is capable of, configured to, or operable to support a means for transmitting SDT data in the second BWP as part of the SDT procedure in accordance with the trigger for BWP switching, where transmission of the SDT data is over a configured grant resource set.

By including or configuring the communications manager 820 in accordance with examples as described herein, the device 805 may support techniques for improved SDT procedures while a UE is operating in RRC active or RRC inactive states. The SDT procedure may be initiated in a first BWP and then continue in a second BWP in response to a BWP switching trigger.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of procedures for SDT as described herein, or the at least one processor 840 and the at least one memory 830 may be otherwise configured to, individually or collectively, perform or support such operations.

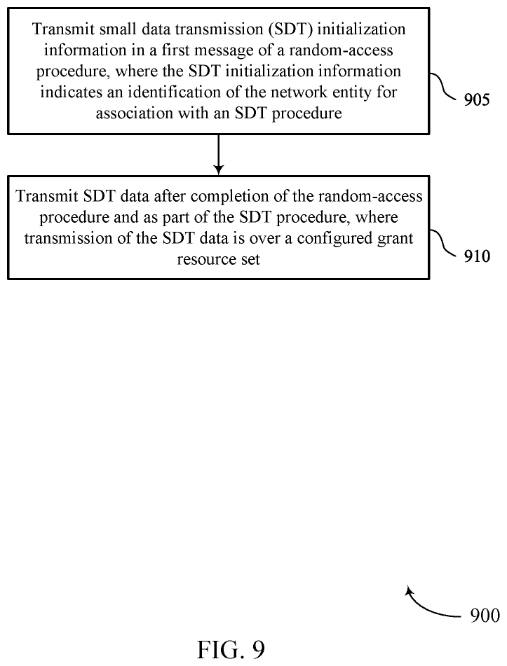

FIG. 9 shows a flowchart illustrating a method 900 that supports procedures for SDT in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting SDT initialization information in a first message of a random-access procedure, where the SDT initialization information indicates an identification of the network entity for association with an SDT procedure. The operations of 905 may be performed in accordance with examples as disclosed herein. In some examples, aspects of the operations of 905 may be performed by an SDT Initialization manager 725 as described with reference to FIG. 7.

At 910, the method may include transmitting SDT data after completion of the random-access procedure and as part of the SDT procedure, where transmission of the SDT data is over a configured grant resource set. The operations of 910 may be performed in accordance with examples as disclosed herein. In some examples, aspects of the operations of 910 may be performed by an SDT manager 730 as described with reference to FIG. 7.

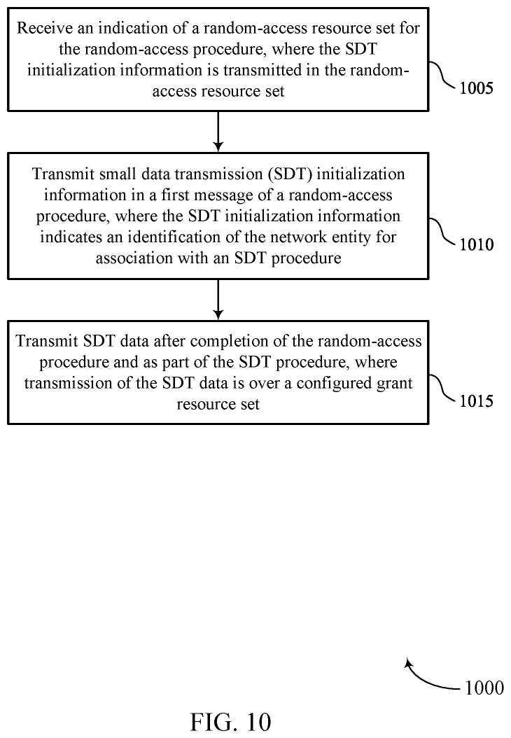

FIG. 10 shows a flowchart illustrating a method 1000 that supports procedures for SDT in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving an indication of a random-access resource set for the random-access procedure, where the SDT initialization information is transmitted in the random-access resource set. The operations of 1005 may be performed in accordance with examples as disclosed herein. In some examples, aspects of the operations of 1005 may be performed by a RACH manager 740 as described with reference to FIG. 7.

At 1010, the method may include transmitting SDT initialization information in a first message of a random-access procedure, where the SDT initialization information indicates an identification of the network entity for association with an SDT procedure. The operations of 1010 may be performed in accordance with examples as disclosed herein. In some examples, aspects of the operations of 1010 may be performed by an SDT Initialization manager 725 as described with reference to FIG. 7.

At 1015, the method may include transmitting SDT data after completion of the random-access procedure and as part of the SDT procedure, where transmission of the SDT data is over a configured grant resource set. The operations of 1015 may be performed in accordance with examples as disclosed herein. In some examples, aspects of the operations of 1015 may be performed by an SDT manager 730 as described with reference to FIG. 7.

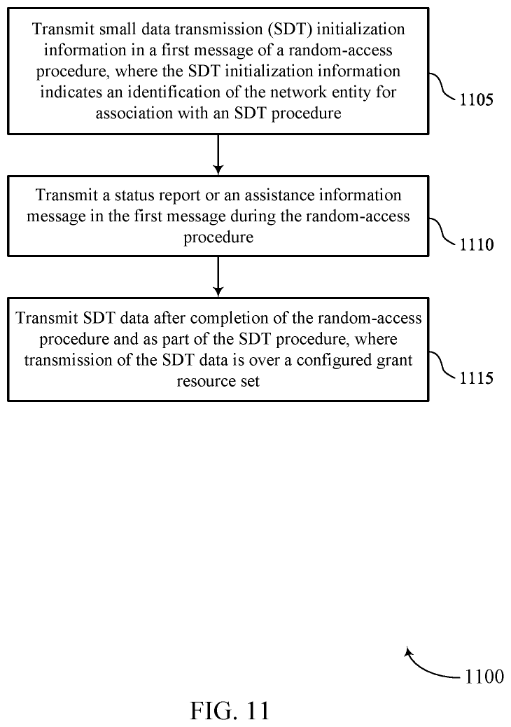

FIG. 11 shows a flowchart illustrating a method 1100 that supports procedures for SDT in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include transmitting SDT initialization information in a first message of a random-access procedure, where the SDT initialization information indicates an identification of the network entity for association with an SDT procedure. The operations of 1105 may be performed in accordance with examples as disclosed herein. In some examples, aspects of the operations of 1105 may be performed by an SDT Initialization manager 725 as described with reference to FIG. 7.

At 1110, the method may include transmitting a status report or an assistance information message in the first message during the random-access procedure. The operations of 1110 may be performed in accordance with examples as disclosed herein. In some examples, aspects of the operations of 1110 may be performed by an SDT data manager 745 as described with reference to FIG. 7.

At 1115, the method may include transmitting SDT data after completion of the random-access procedure and as part of the SDT procedure, where transmission of the SDT data is over a configured grant resource set. The operations of 1115 may be performed in accordance with examples as disclosed herein. In some examples, aspects of the operations of 1115 may be performed by an SDT manager 730 as described with reference to FIG. 7.

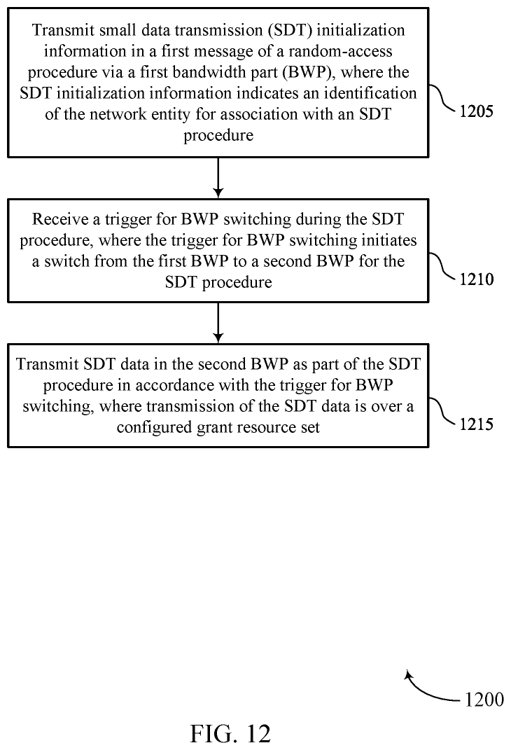

FIG. 12 shows a flowchart illustrating a method 1200 that supports procedures for SDT in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include transmitting SDT initialization information in a first message of a random-access procedure via a first BWP, where the SDT initialization information indicates an identification of the network entity for association with an SDT procedure. The operations of 1205 may be performed in accordance with examples as disclosed herein. In some examples, aspects of the operations of 1205 may be performed by an SDT Initialization manager 725 as described with reference to FIG. 7.

At 1210, the method may include receiving a trigger for BWP switching during the SDT procedure, where the trigger for BWP switching initiates a switch from the first BWP to a second BWP for the SDT procedure. The operations of 1210 may be performed in accordance with examples as disclosed herein. In some examples, aspects of the operations of 1210 may be performed by a BWP trigger manager 735 as described with reference to FIG. 7.

At 1215, the method may include transmitting SDT data in the second BWP as part of the SDT procedure in accordance with the trigger for BWP switching, where transmission of the SDT data is over a configured grant resource set. The operations of 1215 may be performed in accordance with examples as disclosed herein. In some examples, aspects of the operations of 1215 may be performed by an SDT manager 730 as described with reference to FIG. 7.

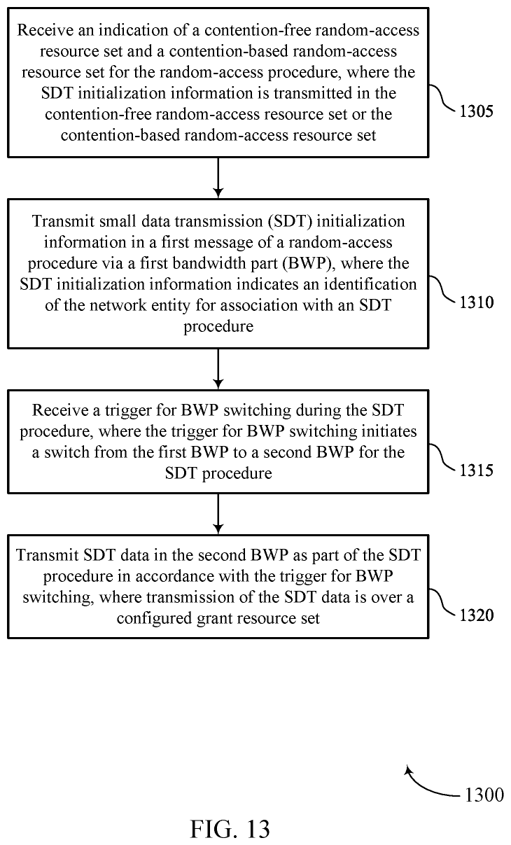

FIG. 13 shows a flowchart illustrating a method 1300 that supports procedures for SDT in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a contention-free random-access resource set and a contention-based random-access resource set for the random-access procedure, where the SDT initialization information is transmitted in the contention-free random-access resource set or the contention-based random-access resource set. The operations of 1305 may be performed in accordance with examples as disclosed herein. In some examples, aspects of the operations of 1305 may be performed by a RACH manager 740 as described with reference to FIG. 7.

At 1310, the method may include transmitting SDT initialization information in a first message of a random-access procedure via a first BWP, where the SDT initialization information indicates an identification of the network entity for association with an SDT procedure. The operations of 1310 may be performed in accordance with examples as disclosed herein. In some examples, aspects of the operations of 1310 may be performed by an SDT Initialization manager 725 as described with reference to FIG. 7.

At 1315, the method may include receiving a trigger for BWP switching during the SDT procedure, where the trigger for BWP switching initiates a switch from the first BWP to a second BWP for the SDT procedure. The operations of 1315 may be performed in accordance with examples as disclosed herein. In some examples, aspects of the operations of 1315 may be performed by a BWP trigger manager 735 as described with reference to FIG. 7.

At 1320, the method may include transmitting SDT data in the second BWP as part of the SDT procedure in accordance with the trigger for BWP switching, where transmission of the SDT data is over a configured grant resource set. The operations of 1320 may be performed in accordance with examples as disclosed herein. In some examples, aspects of the operations of 1320 may be performed by an SDT manager 730 as described with reference to FIG. 7.

The following provides an overview of aspects of the present disclosure:

Aspect 1: A method for wireless communications at a network entity, comprising: transmitting SDT initialization information in a first message of a random-access procedure, wherein the SDT initialization information indicates an identification of the network entity for association with an SDT procedure; and transmitting SDT data after completion of the random-access procedure and as part of the SDT procedure, wherein transmission of the SDT data is over a CG resource set.

Aspect 2: The method of aspect 1, further comprising: receiving an indication of a random-access resource set for the random-access procedure, wherein the SDT initialization information is transmitted in the random-access resource set.

Aspect 3: The method of aspect 2, wherein the random-access resource set includes dedicated SDT resources for the SDT procedure, and the identification of the network entity is indicated in the SDT initialization information based on the random-access resource set that includes the dedicated SDT resources for the SDT procedure.

Aspect 4: The method of any of aspects 2 through 3, wherein the random-access resource set includes non-dedicated SDT resources for the SDT procedure, further comprising: indicating a request for the SDT procedure in the first message based on the random-access resource set that includes the non-dedicated SDT resources for the SDT procedure.

Aspect 5: The method of any of aspects 2 through 4, wherein the random-access resource set is received in an RRC release message, a DCI message, a system information message, or a MAC-CE.

Aspect 6: The method of any of aspects 2 through 5, wherein the random-access resource set comprises a CFRA resource set or a CBRA resource set.

Aspect 7: The method of any of aspects 2 through 6, further comprising: indicating a request for the SDT procedure in the first message, wherein the request for the SDT procedure activates the CG resource set.

Aspect 8: The method of any of aspects 1 through 7, further comprising: transmitting a status report or an assistance information message in the first message during the random-access procedure.

Aspect 9: The method of aspect 8, further comprising: transmitting an additional status report or an additional assistance information message using the CG resource set and during the SDT procedure.

Aspect 10: The method of aspect 9, wherein the additional status report or the additional assistance information message comprise one or more of a BSR, a PHR, measurements associated with mobility procedures, a CSI report, beam management information, a traffic profile, a power saving requirement, or any combination thereof.

Aspect 11: The method of any of aspects 1 through 10, wherein the SDT initialization information is transmitted while the network entity is in an RRC active state or in an RRC inactive state.

Aspect 12: The method of any of aspects 1 through 11, wherein the CG resource set comprises Type-1 CG resources or Type-2 CG resources.

Aspect 13: The method of any of aspects 1 through 12, wherein transmission of the SDT initialization information initiates the SDT procedure.

Aspect 14: The method of any of aspects 1 through 13, wherein the network entity comprises a UE.

Aspect 15: A method for wireless communications at a network entity, comprising: transmitting SDT initialization information in a first message of a random-access procedure via a first BWP, wherein the SDT initialization information indicates an identification of the network entity for association with an SDT procedure; receiving a trigger for BWP switching during the SDT procedure, wherein the trigger for BWP switching initiates a switch from the first BWP to a second BWP for the SDT procedure; and transmitting SDT data in the second BWP as part of the SDT procedure in accordance with the trigger for BWP switching, wherein transmission of the SDT data is over a CG resource set.

Aspect 16: The method of aspect 15, further comprising: receiving an indication of a CFRA resource set and a CBRA resource set for the random-access procedure, wherein the SDT initialization information is transmitted in the CFRA resource set or the CBRA resource set.

Aspect 17: The method of aspect 16, further comprising: prioritizing the CFRA resource set over the CBRA resource set for transmission of the SDT initialization information based on a channel performance metric satisfying a channel performance threshold or based on a non-expiration status of a timer associated with the CFRA resource set.

Aspect 18: The method of any of aspects 16 through 17, further comprising: prioritizing the CBRA resource set over the CFRA resource set for transmission of the SDT initialization information based on a channel performance metric failing to satisfy a channel performance threshold or based on an expiration status of a timer associated with the CFRA resource set.

Aspect 19: The method of any of aspects 15 through 18, further comprising: receiving an indication of a CBRA resource set for the random-access procedure, wherein the CBRA resource set comprises a two-step random-access procedure or a four-step random-access procedure.

Aspect 20: The method of aspect 19, further comprising: prioritizing the two-step random-access procedure over the four-step random-access procedure for transmission of the SDT initialization information based on a channel performance measurement that satisfies a channel performance threshold, based on a non-expiration status of a timer associated with the CBRA resource set, or based on a message retransmission counter that is below a retransmission count threshold.

Aspect 21: The method of any of aspects 19 through 20, further comprising: prioritizing the four-step random-access procedure over the two-step random-access procedure for transmission of the SDT initialization information based on a channel performance measurement that fails to satisfy a channel performance threshold, based on an expiration status of a timer associated with the CBRA resource set, or based on a message retransmission counter that has reached a retransmission count threshold.

Aspect 22: The method of any of aspects 15 through 21, wherein the trigger for BWP switching is received in an RRC message, a MAC-CE, or a DCI message.

Aspect 23: The method of any of aspects 15 through 22, wherein the CG resource set comprises Type-1 CG resources or Type-2 CG resources.

Aspect 24: The method of any of aspects 15 through 23, wherein transmission of the SDT initialization information initiates the SDT procedure.

Aspect 25: The method of any of aspects 15 through 24, wherein the network entity comprises a UE.

Aspect 26: A network entity for wireless communications, comprising a processing system configured to perform a method of any of aspects 1 through 14.

Aspect 27: A network entity for wireless communications, comprising at least one means for performing a method of any of aspects 1 through 14.

Aspect 28: A non-transitory computer-readable medium having code for wireless communications stored thereon that, when executed by a network entity, causes the network entity to perform a method of any of aspects 1 through 14.

Aspect 29: A network entity for wireless communications, comprising a processing system configured to perform a method of any of aspects 15 through 25.

Aspect 30: A network entity for wireless communications, comprising at least one means for performing a method of any of aspects 15 through 25.

Aspect 31: A non-transitory computer-readable medium having code for wireless communications stored thereon that, when executed by a network entity, causes the network entity to perform a method of any of aspects 15 through 25.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, structures and devices are shown in block diagram form in order to avoid obscuring the concepts of the described aspects.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the aspects and designs described herein but is to be accorded the broadest scope consistent with the principles and novel features disclosed herein.

What is claimed is:

1. A network entity for wireless communications, comprising:
a processing system configured to:
transmit (SDT) initialization information in a first message of a random-access procedure, wherein the SDT initialization information indicates an identification of the network entity for association with an SDT procedure; and
transmit SDT data after completion of the random-access procedure and as part of the SDT procedure, wherein transmission of the SDT data is over a configured grant resource set.

2. The network entity of claim 1, wherein the processing system is configured to:
receive an indication of a random-access resource set for the random-access procedure, wherein the SDT initialization information is transmitted in the random-access resource set.

3. The network entity of claim 2, wherein:
the random-access resource set includes dedicated SDT resources for the SDT procedure, and
the identification of the network entity is indicated in the SDT initialization information based on the random-access resource set that includes the dedicated SDT resources for the SDT procedure.

4. The network entity of claim 2, wherein the processing system is configured to:
indicate a request for the SDT procedure in the first message based on the random-access resource set that includes a non-dedicated SDT resources for the SDT procedure.

5. The network entity of claim 2, wherein the random-access resource set is received in a radio resource control (RRC) release message, a downlink control information (DCI) message, a system information message, or a medium access control-control element (MAC-CE).

6. The network entity of claim 2, wherein the random-access resource set comprises a contention-free random-access resource set or a contention-based random-access resource set.

7. The network entity of claim 2, wherein the processing system is configured to:
indicate a request for the SDT procedure in the first message, wherein the request for the SDT procedure activates the configured grant resource set.

8. The network entity of claim 1, wherein the processing system is configured to:
transmit a status report or an assistance information message in the first message during the random-access procedure.

9. The network entity of claim 8, wherein the processing system is configured to:
transmit an additional status report or an additional assistance information message using the configured grant resource set and during the SDT procedure.

10. The network entity of claim 9, wherein the additional status report or the additional assistance information message comprise one or more of a buffer status report, a power headroom report, measurements associated with mobility procedures, a channel state information report, beam management information, a traffic profile, a power saving requirement, or any combination thereof.

11. The network entity of claim 1, wherein the SDT initialization information is transmitted while the network entity is in a radio resource control (RRC) active state or in an RRC inactive state.

12. The network entity of claim 1, wherein the configured grant resource set comprises Type-1 configured grant resources or Type-2 configured grant resources.

13. The network entity of claim 1, wherein transmission of the SDT initialization information initiates the SDT procedure.

14. The network entity of claim 1, wherein the network entity comprises a user equipment (UE).

15. A network entity, comprising:
a processing system configured to:
transmit small data transmission (SDT) initialization information in a first message of a random-access procedure via a first bandwidth part (BWP), wherein the SDT initialization information indicates an identification of the network entity for association with an SDT procedure;
receive a trigger for BWP switching during the SDT procedure, wherein the trigger for BWP switching initiates a switch from the first BWP to a second BWP for the SDT procedure; and
transmit SDT data in the second BWP as part of the SDT procedure in accordance with the trigger for BWP switching, wherein transmission of the SDT data is over a configured grant resource set.

16. The network entity of claim 15, wherein the processing system is configured to:
receive an indication of a contention-free random-access resource set and a contention-based random-access resource set for the random-access procedure, wherein the SDT initialization information is transmitted in the contention-free random-access resource set or the contention-based random-access resource set.

17. The network entity of claim 16, wherein the processing system is configured to:
prioritize the contention-free random-access resource set over the contention-based random-access resource set for transmission of the SDT initialization information based on a channel performance metric satisfying a channel performance threshold or based on a non-expiration status of a timer associated with the contention-free random-access resource set.

18. The network entity of claim 16, wherein the processing system is configured to:
prioritize the contention-based random-access resource set over the contention-free random-access resource set for transmission of the SDT initialization information based on a channel performance metric failing to satisfy a channel performance threshold or based on an expiration status of a timer associated with the contention-free random-access resource set.

19. The network entity of claim 15, wherein the processing system is configured to:
receive an indication of a contention-based random-access resource set for the random-access procedure, wherein the contention-based random-access resource set comprises a two-step random-access procedure or a four-step random-access procedure.

20. The network entity of claim 19, wherein the processing system is configured to:
prioritize the two-step random-access procedure over the four-step random-access procedure for transmission of the SDT initialization information based on a channel performance measurement that satisfies a channel performance threshold, based on a non-expiration status of a timer associated with the contention-based random-access resource set, or based on a message retransmission counter that is below a retransmission count threshold.

21. The network entity of claim 19, wherein the processing system is configured to:
prioritize the four-step random-access procedure over the two-step random-access procedure for transmission of the SDT initialization information based on a channel performance measurement that fails to satisfy a channel performance threshold, based on an expiration status of a timer associated with the contention-based random-access resource set, or based on a message retransmission counter that has reached a retransmission count threshold.

22. The network entity of claim 15, wherein the trigger for BWP switching is received in a radio resource control (RRC) message, a medium access control-control element (MAC-CE), or a downlink control information (DCI) message.

23. The network entity of claim 15, wherein the configured grant resource set comprises Type-1 configured grant resources or Type-2 configured grant resources.

24. The network entity of claim 15, wherein transmission of the SDT initialization information initiates the SDT procedure.

25. The network entity of claim 15, wherein the network entity comprises a user equipment (UE).

26. A method for wireless communications at a network entity, comprising:
transmitting small data transmission (SDT) initialization information in a first message of a random-access procedure, wherein the SDT initialization information indicates an identification of the network entity for association with an SDT procedure; and
transmitting SDT data after completion of the random-access procedure and as part of the SDT procedure, wherein transmission of the SDT data is over a configured grant resource set.

27. The method of claim 26, further comprising:
receiving an indication of a random-access resource set for the random-access procedure, wherein the SDT initialization information is transmitted in the random-access resource set.

28. The method of claim 27, wherein:
the random-access resource set includes dedicated SDT resources for the SDT procedure, and
the identification of the network entity is indicated in the SDT initialization information based on the random-access resource set that includes the dedicated SDT resources for the SDT procedure.

29. The method of claim 27, wherein the random-access resource set includes non-dedicated SDT resources for the SDT procedure, further comprising:
indicating a request for the SDT procedure in the first message based on the random-access resource set that includes the non-dedicated SDT resources for the SDT procedure.

30. A method for wireless communications at a network entity, comprising:
transmitting small data transmission (SDT) initialization information in a first message of a random-access procedure via a first bandwidth part (BWP), wherein the SDT initialization information indicates an identification of the network entity for association with an SDT procedure;
receiving a trigger for BWP switching during the SDT procedure, wherein the trigger for BWP switching initiates a switch from the first BWP to a second BWP for the SDT procedure; and
transmitting SDT data in the second BWP as part of the SDT procedure in accordance with the trigger for BWP switching, wherein transmission of the SDT data is over a configured grant resource set.
